(19) United States
(12) Patent Application Publication
(10) Pub. No.: US 2014/0175953 A1
(43) Pub. Date: Jun. 26, 2014

(54) Monitoring Device for a Double-Fed Asynchronous Machine

(71) Applicant: Voith Patent GmbH, Heidenheim (DE)

(72) Inventors: Thomas Hildinger, Heidenheim (DE); Ludger Kodding, Heidenheim (DE)

(21) Appl. No.: 14/122,225

(22) PCT Filed: Jun. 14, 2012
(86) PCT No.: PCT/EP2012/002502

§ 371 Date: Jan. 22, 2014

(30) Foreign Application Priority Data
Feb. 27, 2011 (DE) 10 2011 108 591.6

(51) Int. Cl. H02K 11/00

(52) U.S. Cl. CPC H02K 11/001
USPC 310/68 C

(57) ABSTRACT

The invention concerns a monitoring device for a double-fed electrodynamic asynchronous machine, having
a stator and a rotor body held rotatably therein, whose shaft is mounted on at least one bearing, and
at least one insulation layer for electrical insulation of the rotor body with respect to a zero potential.

The invention is characterised by
at least one contact element for tapping an electric voltage, which is applied with respect to the zero potential by means of said at last one insulation layer, and
a measuring and signalling unit, which is connected to the contact elements for measuring the applied voltage and is designed for emitting a warning signal depending on the height of said voltage.

The invention concerns a monitoring device for a double-fed electrodynamic asynchronous machine according to the preamble of claim 1, as well as a matching method for monitoring a double-fed electrodynamic machine according to claim 10. Furthermore, the invention concerns a preferred use of the monitoring device according to claim 13.

When the insulation of the bearing breaks with electrodynamic machines, a shaft current is generated by the asymmetry of the machine between the shaft ends of the same, which may damage the bearings of the machine. The bearings aforementioned can then comprise all types of bearing units, but in particular guide bearings, support bearings and/or thrust bearings. The extent of the damage thus depends on the height and duration of the shaft current. With synchronous machines, there are monitoring devices for timely detection of such shaft current, so as to detect shaft currents of one ampere or less, such as for instance the ABB Raric Shaft Current Protection. The monitoring is based on the fact that the shaft current is measured and that limit values are defined, whereby a signal is emitted when they are exceeded

In the case of double-fed asynchronous machines, there is conversely only a shaft current since the three phase voltages of the converter do not add up to zero. Furthermore, very high voltage variations or very high frequency in terms of voltage harmonics taking into account the clocked voltage intrusion. Different shaft currents hence crop up according to the operating mode so that the conventional shaft current monitoring, for instance of the ABB, cannot be used. It must still be avoided that shaft currents flow across the insulation layer or the oil film from the shaft to a bearing.

Publication DE 196 34 366 A1 discloses a device with the assistance of which electrical parameters such as the insulation resistance of an asynchronous motor can be determined. The voltage is hence tapped via probes on the motor terminal lugs.

Publication DE 15 13 706 A shows how to measure a voltage in relation to mass via an insulation, on the rotating parts of a synchronous machine. The voltage is tapped via brushes and slip rings. The insulation layer then insulates a rotating circuit from the threshold of the synchronous machine, whereas the threshold is used as a mass.

The object of the present invention is to offer a monitoring device for a double-fed electrodynamic asynchronous machine, which solves the above problems and enables simple, efficient and reliable monitoring of the shaft current.

This object is met by a monitoring device according to the characterising part of claim 1. The solution according to the invention first of all proceeds from the assumption that the path of the current should be monitored and measured via an insulation layer. Since with double-fed asynchronous machines indeed shaft currents always crop up, it is impossible to draw conclusions about the condition of the machine. A significant point of the monitoring device according to the invention lies only in determining not the current, but the voltage via an insulation layer and in drawing conclusions about the condition of the same thanks to said determination.

The voltage is then measured against a zero potential that is usually applied to the stator of the double-fed electrodynamic asynchronous machine. A corresponding measuring and signalling unit is hence connected to contact element for measuring the voltage, as well as designed for emitting a warning signal which reflects the condition of the machine and enables to decide on the pursuit of the procedure. Advantageous further developments of the monitoring device are specified in the depending claims, which concern in particular suitable measuring points and their configuration.

It is then provided in a preferred embodiment that said at least one bearing comprises an annular first insulation layer. The definition of a voltage drop directly via the bearing then constitutes shortest way to establish a leakage current and hence a damage of the machine. The necessary contact points can thus be provided on or in the bearing inasmuch as a modular pivot and measuring device is available, which renders additional modifications of the equipment superfluous.

The above first insulation layer is hence designed as an oil film advantageously as it is necessary in many bearings for their lubrication. Consequently this dispenses with the additional mounting of a suitable insulation layer on or in the bearing. Ideally, said at least one bearing is designed as a slide bearing, which uses an oil film or another appropriate lubricant film without further contact bridges such as for instance ball or roller bearings.

In an alternative or additional embodiment, a second annular insulation layer is arranged between said at least one bearing and the shaft. This can be necessary as the bearing on its own does not offer a sufficient resistance to leakage current and thus does not render any voltage drop measurable. If it is conversely not the case, the failsafe performance of the machine can be increased by mounting the additional insulation. In every case, it is further possible to measure a voltage drop and to guarantee reliable monitoring of the machine. Ideally, the second insulation layer is designed as a fibre glass layer, a polyester film or a Kapton film, which ensures equally stable connection of shaft and bearing as well as reliable insulation.

The contact elements are preferably designed as fixed brushes, which are arranged seen in radial direction of the shaft before the first and/or the second insulation layer. Such a structural design of the contact elements can be realised particularly straightforwardly and in particular requires no potentially significantly more vulnerable electronics. It can also be envisioned to provide a rotating contact element which is for instance fitted with a Bluetooth interface.

A particularly flexible measuring and signalling unit is designed for storing a voltage limit and for emitting the warning signal when falling below said voltage limit. Consequently, different voltage limits can be provided (depending on each machine configuration and their safety requirements) which enable monitoring to suit the respective situation. Such a measuring and signalling unit can be used in particular for different machine types and load scenarios.

The monitoring device according to the invention is preferably fitted with a disconnection unit which is designed for switching off the double-fed electrodynamic asynchronous machine in reaction to the warning signal. A potential damage of the machine is excluded reliably.

The object designated initially is also solved by a method according to claim 10 for which a voltage drop is measured via a corresponding insulation layer of the bearing and/or between said bearing and the shaft. Said method also allows particularly straightforward, efficient and reliable monitoring of a double-fed electrodynamic asynchronous machine. There is a particularly good flexibility if a voltage limit can be preset for which a warning signal is emitted when falling below said voltage limit. Ideally, the double-fed electrodynamic asynchronous machine is switched off in reaction to the warning signal emitted so as to exclude any damage to their bearings.

Particularly, the monitoring device is installed in a motor generator which is subjected to high alternating loads.

The present invention is described more in detail below using an embodiment example with reference to the appended figures. Identical or equivalent parts are specified with identical numerals. The figures are as follows:

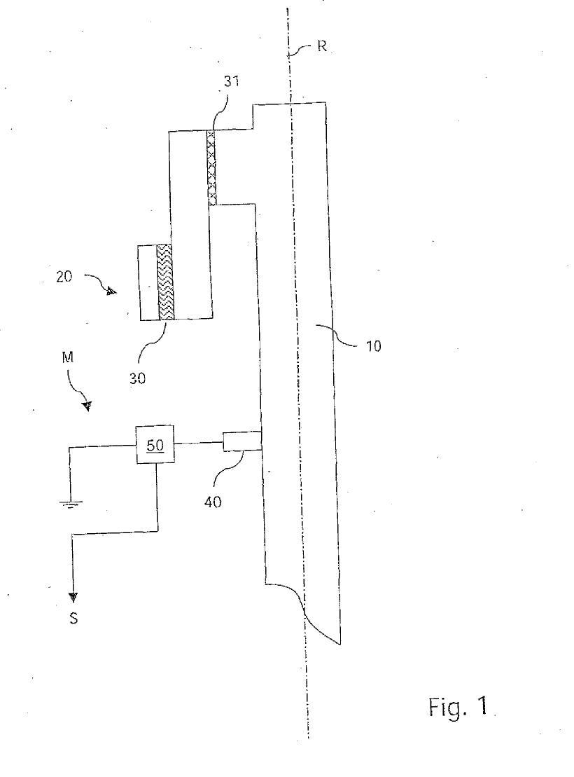

FIG. 1 a first embodiment of a monitoring device according to the invention for a double-fed electrodynamic asynchronous machine, which detects the voltage drop across two insulation layers which are arranged for the one in a bearing and for the other between said bearing and the shaft of an electrodynamic asynchronous machine, and

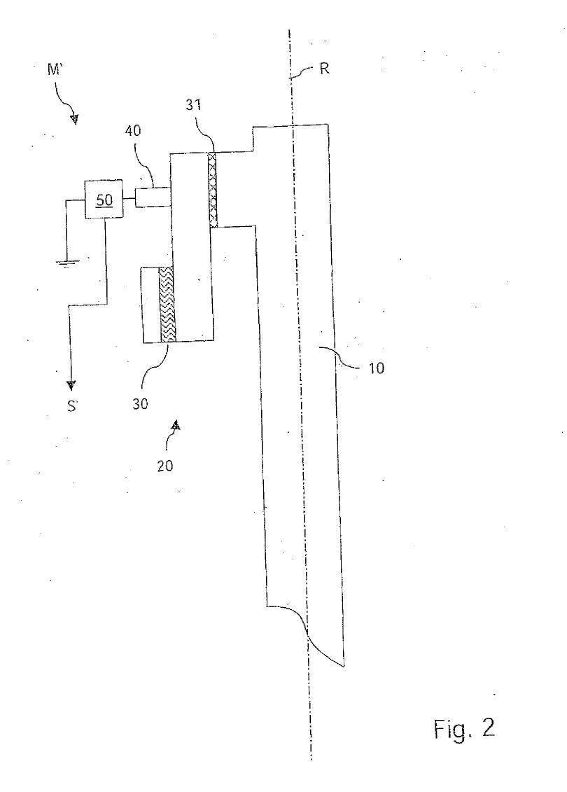

FIG. 2 a second embodiment of a monitoring device according to the invention for a double-fed electrodynamic asynchronous machine, which detects the voltage drop across only one of the insulation layers of FIG. 1, namely the one which is arranged in the bearing of the electrodynamic asynchronous machine.

FIG. 1 shows a first embodiment of a monitoring device according to the invention (M) for a double-fed electrodynamic asynchronous machine, which detects the voltage drop across two insulation layers 30, 31 which are arranged for the one in a bearing 20 and for the other between said bearing 20 and the shaft 10 of an electrodynamic asynchronous machine. The bearing 20 should hence be arranged as a slide bearing with an oil film, which acts as the first insulation layer 30. The second insulation layer 31 hence rotates with the shaft 10 when said shaft revolves around its rotational axis R. A contact element 40 lies against the shaft 10 which is designed as a brush and connected to a measuring and signalling unit 50. Said unit 50 measures a voltage drop across the insulation layers 30, 31 up to a zero potential that is usually applied to the stator of the asynchronous machine. The unit 50 is designed in such a way that a warning signal S is emitted when falling below a prescribed voltage limit which indicates a leakage current. In reaction to said signal S, the machine may for instance be shut down to avoid any damage to the bearing 20.

The represented configuration of the monitoring device M should hence only be understood by way of example; so the brush 40 could for instance abut against the shaft 10 adjoining the second insulation layer 31, which would enable a more compact construction.

The monitoring device M can thus be provided on an upper as well as on a lower (not represented) bearing 20 of the shaft 10, but preferably at each bearing, which is exposed to particularly high loads and whose operation may not be exposed to even short-term interferences.

FIG. 2 shows a second embodiment of a monitoring device according to the invention (M′) for a double-fed electrodynamic asynchronous machine, which detects the voltage drop across only one of the insulation layers 30, 31 of FIG. 1, namely the one which is arranged in the bearing 20 of the electrodynamic asynchronous machine. The contact element 40 is again designed as a brush which abuts against the part of the bearing 20, part which rotates with the shaft 10. The bearing 20 should also be designed as a slide bearing with an oil film, although other lubricants could be used. The position of the brush 40 enables direct measuring of the voltage drop across the bearing 20 and hence to draw particularly reliable conclusions about its condition. When falling below a voltage limit which is predefinable on the measuring and signalling unit 50 a warning signal S is emitted also with said monitoring device M′ which enables timely turn off of the machine.

The double-fed electrodynamic asynchronous machine can naturally be switched off manually by the operating staff. In which embodiment of the monitoring device M, M′ a (non-illustrated) disconnection unit is always provided which allows an extensively automated and hence reliable execution of said process.

Although the present invention has been described more in detail in relation to a monitoring device for a double fed electrodynamic asynchronous machine, said invention is not at all limited thereto but can be used as a matter of principle in each combination of said machine with additional assemblies, as for instance in a motor generator. Basically, the present invention can naturally be used also in a simple powered electrodynamic asynchronous machine. The advantages according to the invention should be considered in the light thereof. The adaptations of the monitoring device, which are required in every case, in particular the position and the configuration of their contact elements, are well-known to the man of the art.

1-13. (canceled)

14. A double-fed electrodynamic asynchronous machine comprising:
a monitoring device;
a stator and a rotor body held rotatably therein, whose shaft is mounted on at least one bearing;
at least one insulation layer for electrical insulation of the rotor body with respect to a zero potential;
at least one contact element for tapping an electric voltage, which is applied with respect to the zero potential using said at last one insulation layer;
a measuring and signalling unit, which is connected to the contact elements for measuring the applied voltage and is designed for emitting a warning signal depending on the height of said voltage;
wherein said at least one bearing comprises an annular first insulation layer, and wherein a second annular insulation layer is arranged between said at least one bearing and the shaft, wherein the voltage is tapped with respect to the zero potential via the first insulation layer.

15. The asynchronous machine according to claim 14, wherein the first insulation layer is designed as an oil film.

16. The asynchronous machine according to claim 15, wherein said at least one bearing is designed as a slide bearing.

17. The asynchronous machine according to claim 14, wherein the second insulation layer is designed as a fibre glass layer, a polyester film or a Kapton film.

18. The asynchronous machine according to claim 15, wherein the second insulation layer is designed as a fibre glass layer, a polyester film or a Kapton film.

19. The asynchronous machine according to claim 14, wherein the contact elements are designed as fixed brushes, which are arranged seen in radial direction of the shaft before the first and/or the second insulation layer.

20. The asynchronous machine according to claim 15, wherein the contact elements are designed as fixed brushes, which are arranged seen in radial direction of the shaft before the first and/or the second insulation layer.

21. The asynchronous machine according to claim 16, wherein the contact elements are designed as fixed brushes, which are arranged seen in radial direction of the shaft before the first and/or the second insulation layer.

22. The asynchronous machine according to claim 17, wherein the contact elements are designed as fixed brushes, which are arranged seen in radial direction of the shaft before the first and/or the second insulation layer.

23. The asynchronous machine according to claim 18, wherein the contact elements are designed as fixed brushes, which are arranged seen in radial direction of the shaft before the first and/or the second insulation layer.

24. The asynchronous machine according to claim 14, wherein the measuring and signalling unit is designed for storing a voltage limit and for emitting the warning signal when falling below said voltage limit.

25. The asynchronous machine according to claim 15, wherein the measuring and signalling unit is designed for storing a voltage limit and for emitting the warning signal when falling below said voltage limit.

26. The asynchronous machine according to claim 14 further comprising a disconnection unit which is designed for switching off the double-fed electrodynamic asynchronous machine in reaction to the warning signal.

27. The asynchronous machine according to claim 15 further comprising a disconnection unit which is designed for switching off the double-fed electrodynamic asynchronous machine in reaction to the warning signal.

28. The asynchronous machine according to claim 16 further comprising a disconnection unit which is designed for switching off the double-fed electrodynamic asynchronous machine in reaction to the warning signal.

29. The asynchronous machine according to claim 14, wherein the asynchronous machine is a motor generator.

30. A method for monitoring a double-fed electrodynamic asynchronous machine having a stator and a rotor body held rotatably therein, whose shaft is mounted on at least one bearing, and having at least one insulation layer for electrical insulation of the rotor body with respect to a zero potential, in which a second annular insulation layer is arranged between said at least one bearing and the shaft, the method comprising:
measuring an electric voltage;
applying said electric voltage with respect to the zero potential using the insulation layer; and
emitting a warning signal depending on the height of said electric voltage.

31. The method according to claim 30, wherein a voltage limit can be preset, so that the alarm signal is emitted when falling below said voltage limit.

32. The method according to claim 30, wherein the double-fed electrodynamic asynchronous machine is switched off in reaction to the warning signal emitted.

33. The method according to claim 31, wherein the double-fed electrodynamic asynchronous machine is switched off in reaction to the warning signal emitted.
